(19) United States
(12) Patent Application Publication
(10) Pub. No.: US 2026/0087607 A1
(43) Pub. Date: Mar. 26, 2026

(54) Methods, Apparatuses, and Systems for Cleaning, Tracing, and Securing Fibers in Communication Networks

(71) Applicant: Panduit Corp., Tinley Park, IL (US)

(72) Inventors: Jose M. Castro, Naperville, IL (US); Yu Huang, Orland Park, IL (US); Bulent Kose, Burr Ridge, IL (US)

(73) Assignee: Panduit Corp., Tinley Park, IL (US)

(21) Appl. No.: 18/894,239

(22) Filed: Sep. 24, 2024

(51) Int. Cl. G06T 7/00; G06V 10/25; G06V 10/26; G06V 10/75; G06V 20/00; G06V 20/80; H04B 10/2507; H04B 10/2581; H04L 9/06

(52) U.S. Cl. CPC G06T 7/0002; G06V 10/25; G06V 10/26; G06V 10/759; G06V 20/80; G06V 20/95; H04B 10/2507; H04L 9/0643; H04B 10/2581

(57) ABSTRACT

Visual inspection systems, and methods for utilizing such visual inspection systems, are disclosed for providing technological solutions that improve cleanliness, transmission performance, traceability, and security of optical network components such as optical assemblies. The visual inspection systems, and the methods for utilizing such visual inspection systems, also aid in preventing the counterfeiting of network components.

### FIELD OF TECHNOLOGY

This disclosure relates to the field of optical network interconnection, and more specifically to technological solutions for providing improvements to cleanliness, transmission performance, traceability, and security of optical network components such as optical assemblies. The disclosed solutions also relates to methods, apparatuses, and systems for preventing the counterfeiting of network components.

### BACKGROUND

Deploying datacenters is a complex endeavor that involves planning design and construction of the computing, storage, and networking capacity as well as the supportive systems for power, cooling, and security.

Optical connector contamination is a known cause of link failure and delays in major datacenter deployment. Fiber optic links are extremely sensitive to dust, oil, and other contaminants on the mating connector end face, to the point where a single particle placed in the fiber core may completely block the transmission of optical signals. Contaminated connectors may increase losses and reflections, which increase noises in the system such as relative intensity noise or multipath interference.

Therefore, during a network installation it is important to verify that the connector end face is cleaned before connecting it. The degree of cleanliness may be determined with the use of fiber visual inspection systems (VIS), which typically are field equipment that consists of a probe, lenses a camera, and a display to image the end face of the connector. To ensure that each a connector was properly inspected, known solutions may require an installer to enter, by typing or scanning a label, an identification number, or other identifier ID, that is associated with a test report of the evaluated connector. The test report is the traceable piece of information used to confirm that the connector is not contaminated.

In many cases, labels on the optical connectors of the cables might not be available or easily accessible. Even when available, reading them may require a scanning device, or an input device on hand to enter an ID number manually. As the number of connectors per cable increases, and new form factors such as multi-ferrule multifiber connectors become more utilized, the task of inspecting and uniquely identifying each connector becomes burdensome. Due to the pressures of meeting project deadlines, inspecting and cleaning all the optical connectors of assemblies and equipment while accurately documenting the results becomes difficult to achieve in practice for large datacenter installations.

When communication links over the fiber cables fail due to contamination, another crew of testers may come in to identify and locate the failures. In large data centers, this troubleshooting process is time-consuming and can produce delays in the overall deployment project.

### SUMMARY

According to an embodiment, a visual inspection system is disclosed. The visual inspection system comprising a memory configured to store machine executable instructions, and a processor in communication with the memory, the processor configured to execute the machine executable instructions to cause the processor to: receive a captured image of a connector at a field-side location, the connector included in a fiber component, compute a hash function on the captured image to produce a field-side identifier for the fiber component, access a production-side identifier, compare the field-side identifier with the production-side identifier to determine whether there is a match between the field-side identifier and the production-side identifier, and approve an assignment of an identification reference to the fiber component when the field-side identifier and the production-side identifier are determined to match.

According to another embodiment, a visual inspection is disclosed. The visual inspection system comprising a memory configured to store machine executable instructions, and a processor in communication with the memory, the processor configured to execute the machine executable instructions to cause the processor to: receive a field-side captured image of a connector at a field-side location, the connector included in a fiber component, execute a vector image analysis to identify physical attributes on the field-side captured image corresponding to physical attributes on the connector, access a production-side captured image for the connector, compare the field-side captured image with the production-side captured image to determine whether there is a match between the physical attributes identified on the field-side captured image and physical attributes identified on the production-side captured image, and approve an assignment of an identification reference to the fiber component when the field-side captured image and the production-side captured image are determined to match.

A detailed description of this and other non-limiting exemplary embodiments of a visual inspection system and method for utilizing the visual inspection system are set forth below together with the accompanying drawings.

### BRIEF DESCRIPTION OF THE DRAWINGS

FIG. 1 shows exemplary images of single mode fiber (SMF) MPO type connectors captured by a fiber VIS, according to an exemplary embodiment.

FIG. 2 shows exemplary images of multimode fiber (MMF) MPO type connectors captured by a fiber VIS, according to an exemplary embodiment.

FIG. 3 shows a first flowchart describing a process for connector identification that may be taken from a vendor side, and also shows a second flowchart describing a process for field installation of the connector, according to an exemplary embodiment.

FIG. 4A shows a first hatching technique, according to an exemplary embodiment.

FIG. 4B shows a second hatching technique, according to an exemplary embodiment.

FIG. 5 shows exemplary images of twelve regions of interest (ROI) corresponding to fibers captured by a fiber VIS, according to an exemplary embodiment.

FIG. 6 shows exemplary images of features included in a region of interest (feature-ROI) from the images shown in FIG. 5, according to an exemplary embodiment.

FIG. 7 shows image matrices of the feature-ROIs extracted from the images shown in FIG. 6, according to an exemplary embodiment.

FIG. 8A shows an exemplary diagonal matrix representation that plots cross-correlations of all the feature-ROIs from FIG. 7 having non-repetitive correlations, according to an exemplary embodiment.

FIG. 8B shows a vector representation that contains non-repetitive cross-correlations of the feature-ROIs from FIG. 7, according to an exemplary embodiment.

FIG. 9 shows thirty-one non-normalized vectors corresponding to thirty-one images of MMF MPO connectors, according to an exemplary embodiment.

FIG. 10 shows images of repeated connectors from the connectors represented from the vector images shown in FIG. 9.

FIG. 11A shows a diagonal matrix representing a correlation among the thirty-one connector end faces, according to an exemplary embodiment.

FIG. 11B shows a diagonal matrix representing a correlation among the thirty-one connector end faces, according to an exemplary embodiment.

FIG. 11C shows a diagonal matrix representing a correlation among the thirty-one connector end faces, according to an exemplary embodiment.

FIG. 12 shows images of four regions of polymer with embedded dies, according to an exemplary embodiment.

FIG. 13 shows an exemplary computing device system, according to an exemplary embodiment.

FIG. 14 shows an exemplary fiber visual inspection system, according to an exemplary embodiment.

### DETAILED DESCRIPTION

This disclosure describes embodiments of technological solutions for providing improvements to cleanliness, transmission performance, traceability, and security of optical network components such as optical assemblies. The disclosed solution also relates to methods, apparatuses, and systems for preventing the counterfeiting of network components.

The disclosed solution includes a fiber VIS that automatically inspects, evaluates, and documents a connector for cleanliness, and further detects the connector's identifier and verifies an authenticity of the connector product. The disclosed solution is able to provide these advantageous features in a relatively short time (e.g., less than 15 seconds) without the need for an additional scanner, or the need for manually entering an identifier via an input device (e.g., a keyboard).

Here we disclose a solution that may achieve the features described herein. The solution may include hardware, software, circuitry, and any combination thereof. For example, the disclosed solution may include a fiber VIS that enables faster traceable installation of optical networks while improving reliability by reducing the risk of using contaminated connectors. In this way, the disclosed solution provides a secure identification process that relies on physical signatures already present on the products, such as random patterns on the surface of the connectors. The disclosed solution may include methods, devices, and/or systems for detecting and associating the physical properties of a fiber component (e.g., fiber connector) to an identifier that provides more security when compared to existing technologies based only on bar or quick read codes, or RFIDs which can be easily tampered with, copied, or even falsified.

It would be useful to have a VIS, that automatically inspects, evaluates, documents the connector cleanliness, detects the ID, and verifies the authenticity of the product, providing those functions in a relatively short time, e.g., less than 15 seconds, without the need for an additional scanner, or the need for manually entering an ID.

The disclosed solution is a unified tool and process for providing fiber connector inspection cleanliness, identification, authentication, and traceability. The solution includes methods for fast inspection, traceability, and authentication of the fiber connectors being installed within a datacenter to enable efficient datacenter network installation. Previously known methods have been hindered by requiring multiple time-consuming steps to inspect, clean document, install, and troubleshoot the network.

The disclosed solution uniquely utilizes the same materials and processes used in the fabrication of the connector to provide a unique signature that may be used to identify optical network equipment and components such as cassettes, patch cords, or trunk cables.

For example, as a consequence of the use of glass-reinforced plastics needed to provide strength to the fiber optic connectors such as, but not limited to, MPO/MPT, SN-MT, and MMC type connectors, the connectors exhibit a significant degree of randomness in their ferrule end faces. According to a feature of the disclosed solution, these random characteristics on the connectors caused by the plastics may be used to provide an identifier to the connectors.

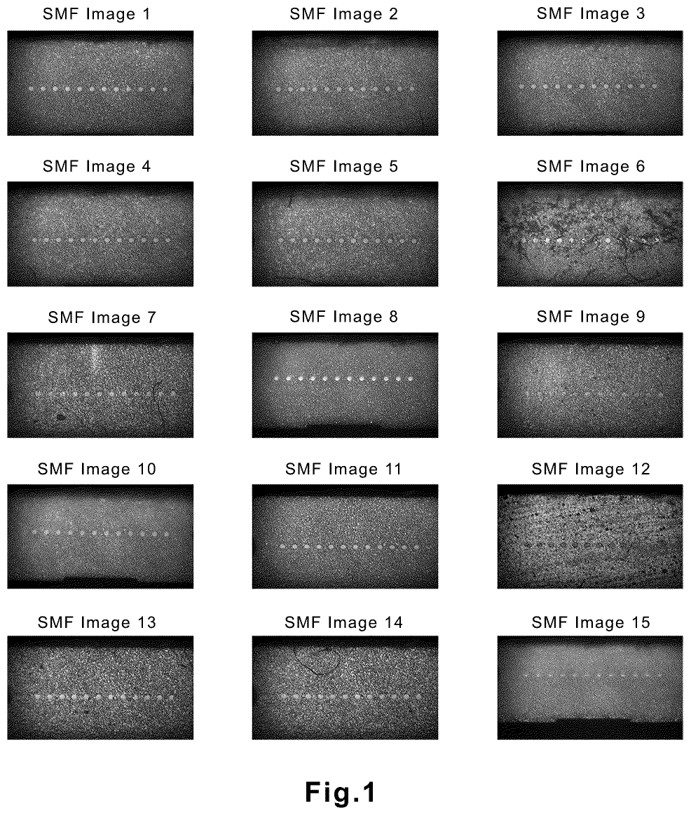

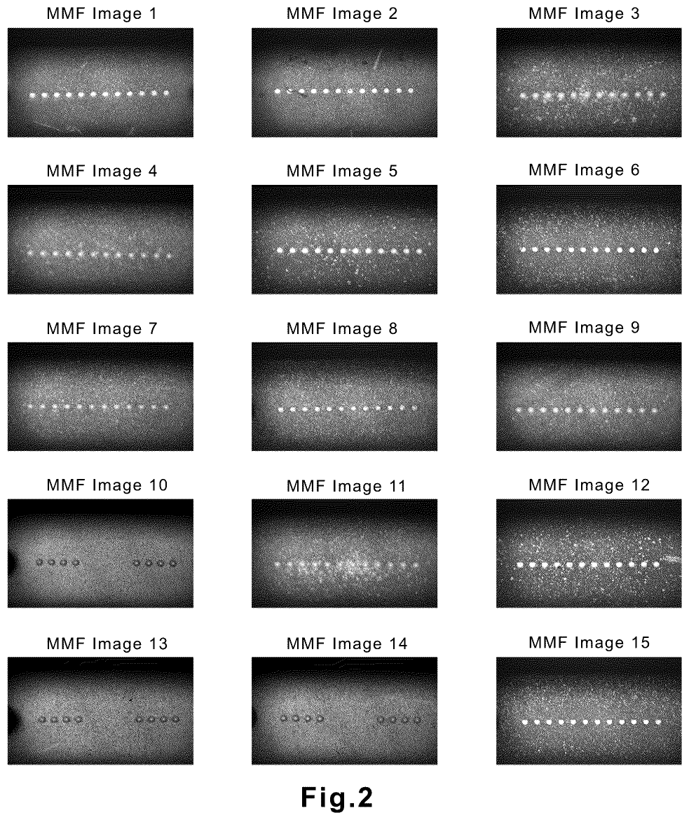

FIG. 1 shows fifteen different exemplary images of MPO connector end faces that were captured using a fiber VIS according to the present solution, where the MPO connectors are single mode fiber (SMF) connectors. FIG. 2 shows fifteen different exemplary images of MPO connector end faces that were captured using a fiber VIS according to the present solution, where the MPO connectors are multimode fiber (MMF) connectors. The images shown in FIG. 1 and FIG. 2 illustrate the random patterns that may be physically found on the connector end faces.

According to some embodiments, additional identifying features may be physically added to the connector, such as marks written with femtosecond lasers on the connector body and/or connector end face. By adding the additional identifying features in this way, this combines the randomness of the identifying marks found on the inherent connector with the deterministic bits of information from the added identifying features. While adding the identifying features may add another layer of unique identification, these additional marks may be written only in small sections to minimize any impact on the performance (losses or reflection) of the connectors. Due to those reasons, it is challenging to encode more than a few bits of information in the added identifying marks. Also, those deterministic identifying marks are easily replicable, providing paths to counterfeit the product. On the other hand, the stochastic distribution of the microscopic pieces of glass that form the random shapes in the inherent connector are embedded at random locations in the polymer, which makes them extremely challenging to replicate and potentially more reliable as an identifier for the corresponding connector.

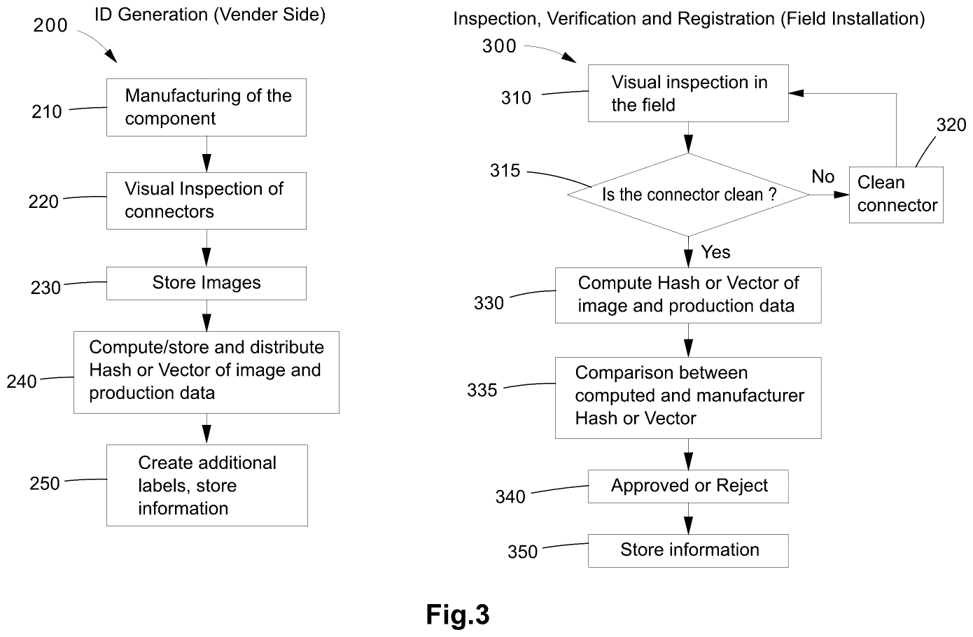

FIG. 3 shows an exemplary first flowchart 200 describing a process for identifying connectors taken, for example, at a vendor side to store identification of a connector prior to an installation at an installation site (e.g., datacenter), according to an exemplary embodiment.

So at 210, the fiber assembly or other fiber component (e.g., fiber cassette) may be manufactured or otherwise received prior to an installation at an installation site.

Then at 220, the corresponding connectors from the fiber assembly may be inspected using a fiber VIS, where the fiber VIS captures an image of the connector end face. For example, the fiber VIS may be the same as described in U.S. Non-provisional Ser. No. 18/097,533 (filed Jan. 17, 2023), U.S. Non-provisional Ser. No. 17/026,591 (filed Sep. 21, 2020), U.S. Non-provisional Ser. No. 17/447,603 (filed Sep. 14, 2021), or U.S. Non-provisional Ser. No. 18/097,533 (filed Jan. 17, 2023), all of which are hereby incorporated by reference herein.

At 230, the captured images of the connector end faces may be stored and processed.

At 240, hashes or vectors are generated using methods described in the following section of this disclosure. The hashes or vectors may be stored and/or distributed to customers of the fiber products.

Then at 250, the hashes or vectors, and/or additional collateral information of the connector end face that are obtained from the captured images of the connector end faces may be further distributed to customers of the fiber products. Additional labels may be created, and the information generated from the process may be stored to be accessed for cross-reference later during an install of the fiber components (e.g., fiber connector).

FIG. 3 also shows an exemplary second flowchart 300 describing a process for a field installation of the fiber component described from flowchart 200, according to an exemplary embodiment. The field installation process may include inspection, verification, and registration of the fiber component at the installation site of the customer (e.g., datacenter).

At 310, visual inspection of the fiber connector from the fiber component (e.g., fiber assemblies and/or cassettes) may be made by a fiber VIS at the deployment site. If the inspected connector end face is determined to be clean by passes a specification standard selected by the fiber VIS, such as standard IEC 61300-3-35, the hashes or vectors are computed at 330.

At 320, if the connector end face is determined not to be clean, the process stops and waits until the operator cleans the connector end face and passes specifications.

At 330, the computation of the hashes or vectors is similar to the one performed in 220, with the difference being that at this stage the connector end face images may have some differences caused by differences in the imaging systems, such as the field of view, resolution or some degree of contamination. The first computation method uses hashes (method A) which are sensitive to those image changes. The second method, labeled here as the vector method (method B), is very robust to those changes as described in the following sections.

At 335, the computed hashes or vectors are compared to the ones provided by the vendor from the process described in flowchart 200. If the compared hashes/vectors are determined to be similar, then at 340 the connector is correctly identified and associated with an identifier (e.g., numerical ID), or if the compared hashes/vectors are determined not to be similar, then the connector may not be identified at this step and the process may attempt to compare the current hash/vector with another hash/vector taken from the vendor side.

At 350, the results of the inspection with the ID, time, location, and optionally an image of the connector end face, the ID of the inspector, and/or additional information may be stored when the inspection is finalized. Depending on the fiber VIS being utilized, this process could take between 5 to 15 seconds requiring minimum expertise from the operator.

Using the processes described by flowchart 200 and flowchart 300, a manager of the network deployment may verify whether all the connectors were inspected, obtain the inspection results, reduce work on the operator, and reduce the inspection time. Having the fiber VIS include wireless communication capabilities such as for WiFi, Bluetooth, or other access capabilities, would further enable the fiber VIS to provide information in real-time. In terms of security, quality, and reliability of the deployment, the comparison of hashes or vectors can verify the authenticity of the fiber products and trace them to vendor records, minimizing the risk of using counterfeit products.

The present solution contemplates utilizing one or more of the following two computation methods, method A and method B, for generating the hashes and vectors described below. Both the method A and the method B solutions focus on the natural randomness of the materials or processes, since they provide a larger capacity for encoding bits and therefore provide unique IDs for each connector. The use of additional markers, such as laser markers, may be used, since in general the methods are agnostic to the shape of the detected patterns, as long as they provide some different features among connectors.

### Method A:

The image of a connector end face may be acquired by the manufacturer of the fiber component (e.g., cassette, patch cord, or trunk cable), as shown, for example, by the captured images from FIGS. 1 and 2. These captured images may be stored by the manufacturer. The fabrication data, e.g., fabrication date, operator, part number among other related information of the fiber connectors, may further be stored. Optionally, a private key may be added.

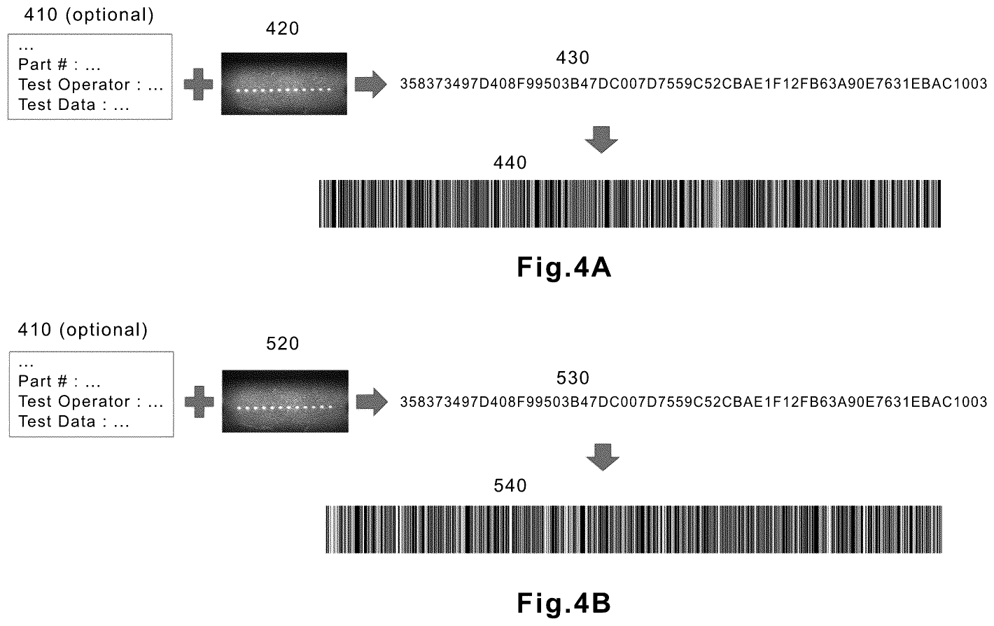

One or more of these data and the connector image data may be used to create a unique digital signature. FIG. 4A illustrates an exemplary Hash function of 128 bits, HASH_1. This exemplary Hash function represented in FIG. 4A may be performed by the vendor. In this case, a first hash data 410 may include optional and shareable data about the process and product. For example, this first hash data 410 may include one or more of a fiber component part number, a fiber component manufacturer, a fiber component manufactured date, a fiber component attribute, a test operator name, or other test data. This first hash data 410 may be combined with the connector end face image 420 to generate a hash 430. The hash 430 may then be converted to a (1D or 2D) barcode 440.

Similarly, at the deployment site a customer may replicate this process as represented by the hash function shown in FIG. 4B using now the connector end face image 520 taken at the deployment site. In this case, the first hash data 410 may be combined with the connector end face image 520 to generate a hash 530. The hash 530 may then be converted to a (1D or 2D) barcode 540.

It should be noted that at the deployment site, the connector end face image 520 could be different from the connector end face image 420 taken at the vendor site, due to contamination or damage in the connector, or because of counterfeit reasons. The fiber VIS may determine whether the connector end face is contaminated, and therefore a contaminated connector end face could be detected and cleaned as described in steps 315 and 320 from the flowchart 300 in FIG. 3.

At the deployment site, the hashes 430 and 530 are compared, and if identical, the connector is identified, its authenticity verified, and the cleanliness information provided by the fiber VIS may be associated with the matched ID, which is a numerical or barcode representation of the hash. At this stage 350 in the flowchart 300 shown in FIG. 3, the reports, images, and ID obtained by the fiber VIS are then stored.

In the described method A, the Hash function enables having a unique identifier with a fixed number of bits. The Hash function provides a one-way physical encryption. This means that it is virtually impossible that the image and fabrication data can be recovered from the Hash and also the probability that two sets of images can produce the same Hash string is extremely low.

This is a desirable feature for safety, but also makes the method very sensitive (e.g., to bit level and positions) to image variations, due to contamination, angle view, or different sensor form factor. Perceptual methods can be used to ensure that visually identical images have the same or very similar hashes independent of small variations in their digital representation caused by relatively small changes in illumination or controlled offsets or tilts. Perceptual hashes should be used to encode only the image and not the additional information referenced as the first hash data 410.

### Method B:

The previous method A relies on hashes, and in particular on robust perceptual hashes obtained from an image of the whole connector end face. These hashes may still be sensitive to relatively small image changes. According to the method B of the present solution, the method B utilizes relationships, particularly correlations, among selected regions of interest (ROIs) found in the images of the connector end face instead of a hash of the whole connector end face image. So according to the present solution, the selected regions are labeled as feature-ROIs, and represented by the function Rₖ(x, y), where k is the index of the region and x, y is the horizontal and vertical coordinates of the image.

The method B evaluation takes advantage of image processing to identify the fibers in the connector's end face by using the location of the identified fibers in the connector end face as reference coordinates, to select the feature-ROIs.

This is an important feature of the method B used in the present solution. Without the reference locations provided by the fibers on the end face of the connectors, the proposed method B would be computationally inefficient, due to the challenges to find the feature-ROIs in a large image of a potentially contaminated connector. Therefore, referencing the fibers as fiduciary markers serve to distribute the location of Rₖ(x, y) along the connector end face, making the method B evaluation more resilient to contamination.

Once the number and location of the feature-ROIs are determined, the relationships between different feature-ROIs may be computed. These relationships may include metrics to measure the degree of similarity between the random patterns of two feature-ROIs being compared. For example, using a set of cross-correlations between normalized feature-ROIs reduces the sensitivity to imaging or variation due to illumination, offsets, connector damage, or contamination, which is a major problem of traditional hash functions.

An example using an MPO connector with Nƒ=12 fiber, and a fiber VIS according to the present solution is utilized to illustrate the required steps to implement method B. It should be noted that in general the method B may be applied to any other connector such as, but not limited to, SN-MT or MMC, having different numbers of fibers, e.g., Nƒ=8, Nƒ=16, Nƒ=24, or Nƒ=23. Also in this example, the feature-ROIs per fiber, Nk=4, produce a total of N=Nƒ×Nk=48 feature-ROIs.

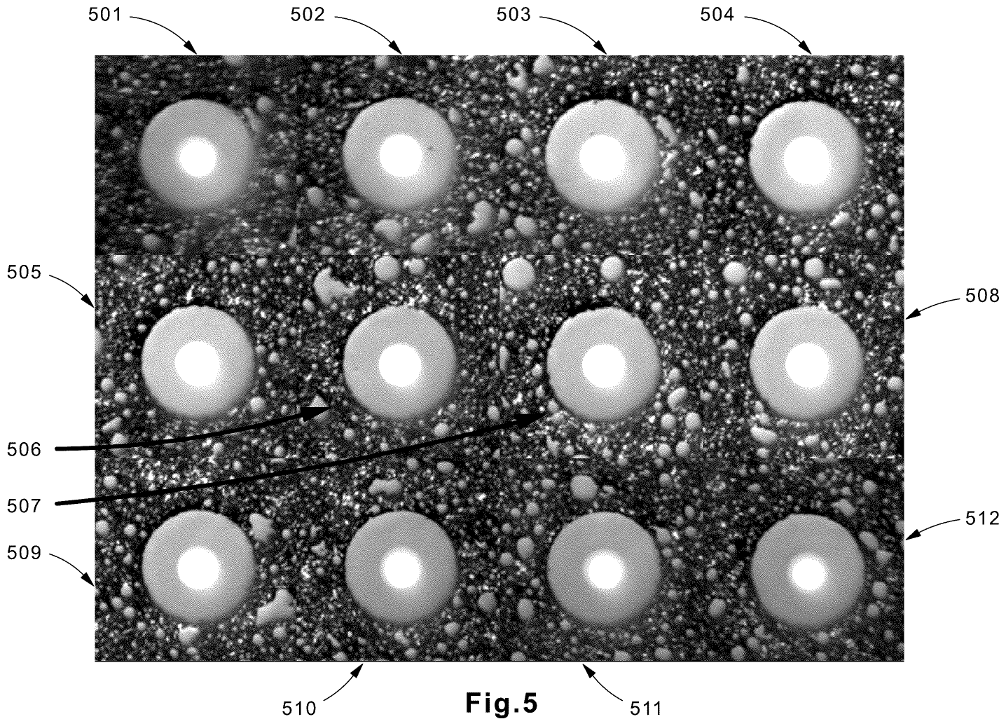

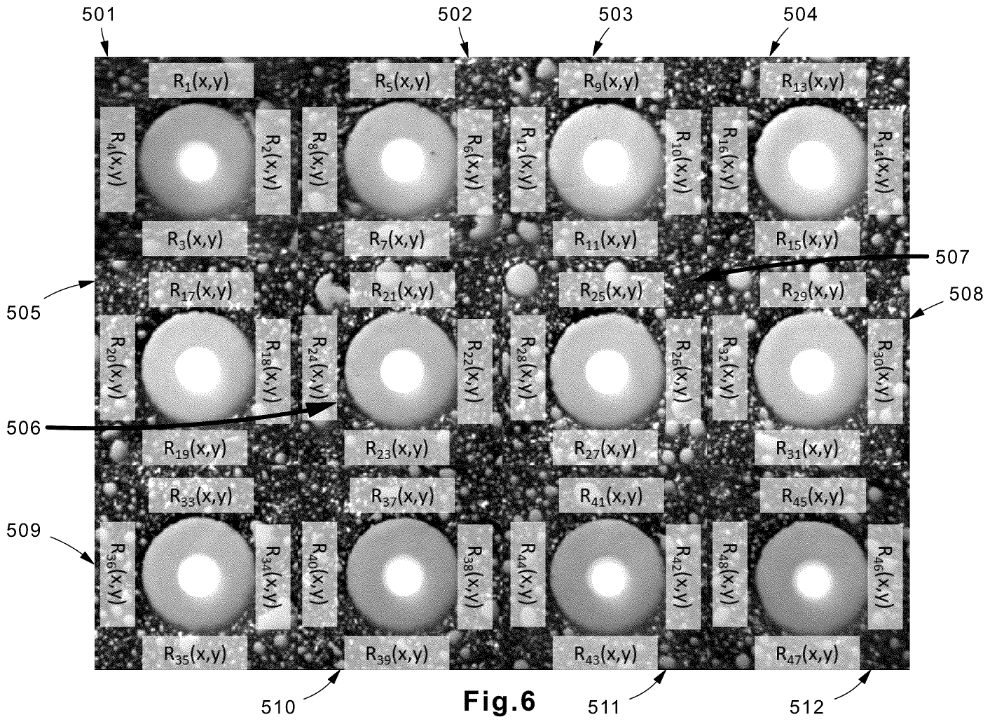

After the fiber VIS localizes the fibers using predetermined algorithms, a set of Nƒ=12 regions of interest (ROIs) around the fibers are selected, as shown in FIG. 5. In FIG. 5, twelve different ROI images 501-512 are shown, where the size of the ROI images in this exemplary embodiment is 320×320 pixels. Note that the location of the ROIs shown in FIG. 5 may not be related to the actual position of the fibers in respective connectors from which the images are captured (e.g., as shown in FIG. 1 or FIG. 2).

FIG. 6 shows the same ROIs from FIG. 5, now with their respective feature-ROI regions identified. For example, inside each of the fiber's ROI images 501-512, the present solution is configured to select Nk=4 feature-ROI regions, located at the top, bottom, left, and right regions around the fiber. This produces the 48 Rₖ(x, y) feature-ROIs shown in FIG. 6. For example, ROI 501 is shown to include feature-ROIs R₁(x, y), R₂(x, y), R₃(x, y), and R₄(x, y).

Each feature-ROI R₁(x, y)−R₄₈(x, y) in the exemplary images shown in FIG. 6 are rectangles of dimensions length=320 pixels and width=40 pixels. In general, other predetermined shapes and/or dimensions may be used for the feature-ROI regions depending on specified detection accuracy and processing power.

Prior to further processing, the DC component of the feature-ROIs is subtracted, and the image is normalized to its RMS value. Therefore, a correlation operation produces a maximum value of 1 or a minimum value of −1.

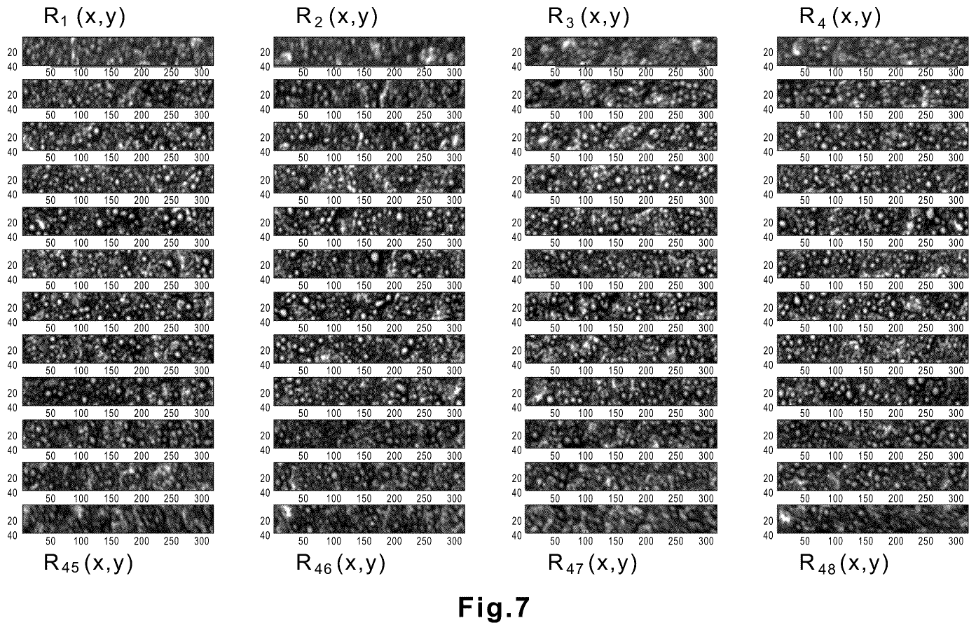

Also, either the left and right images, or the top and down images, from the feature ROIs need to be rotated to produce matrices of identical sizes. The feature-ROIs after these operations are shown in FIG. 7 to be orientated in the same manner and organized into same sized columns.

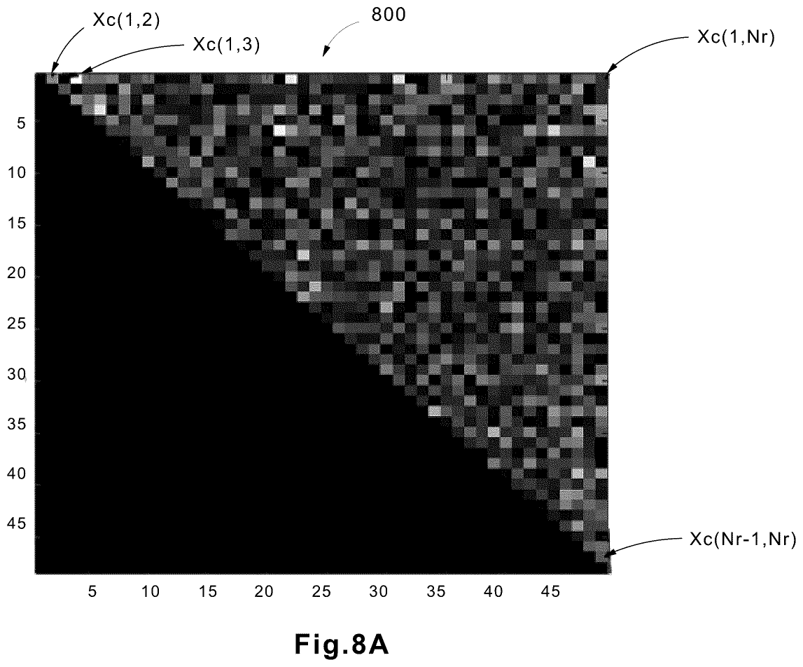

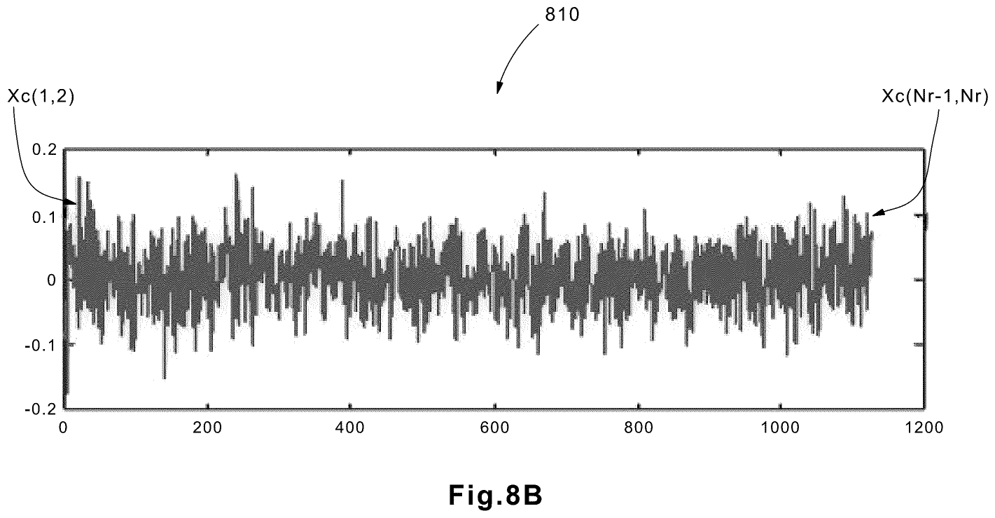

Mathematical operations, e.g., correlations, over those feature-ROIs may produce the vectors needed to identify the connector. The correlations are computed using, for example, Xc(k1,k2)=sum(Rₖ₁(x,y).*Rₖ₂(x,y)),*Rₖ₂(x, y)), where k1 is the row index and k2 is the column index, both in the range of 1 to N. For computation efficiency, k2 is always greater than k1, producing the graph 800 representing the diagonal matrix shown in FIG. 8A. Therefore, there are no repetitive cross-correlations in the matrix Xc, and all the autocorrelations, which do not provide additional information since their value has to be equal to one, are excluded. A vector may be constructed using the elements of the diagonal matrix Xc. The vector size given by N×(N−1) /2, is equal to 1128 in this example. The mapping from matrix to vector may be arbitrary, as long as the selected mapping method is consistently followed during the implementation of method B. So, in this example, the first row of Xc, excluding Xc(1,1) is directly mapped to the first N-1 elements of the vector. The second row, excluding Xc(2,1) and Xc(2,2) are mapped to the adjacent group with N-2 elements. Following this method, the last element of the vector is Xc(47,48).

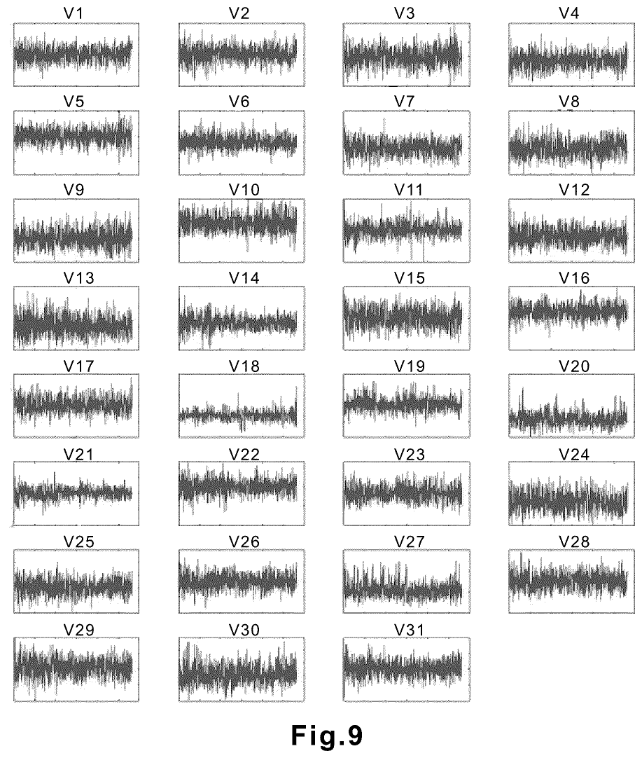

FIG. 9 shows vectors V1-V31 corresponding to thirty-one end face images, that correspond to 25 MPO MMF connectors. Some of the end face images may correspond to the same connector but are taken with different degrees of contamination to test the robustness of the algorithm. For example, the set comprising (V1, V2, V26) vectors correspond to the same connector. Each of vector set (V3, V5), vector set (V4, V6), vector set (V9, V10), and vector set (V7, V15) may correspond to a same connector.

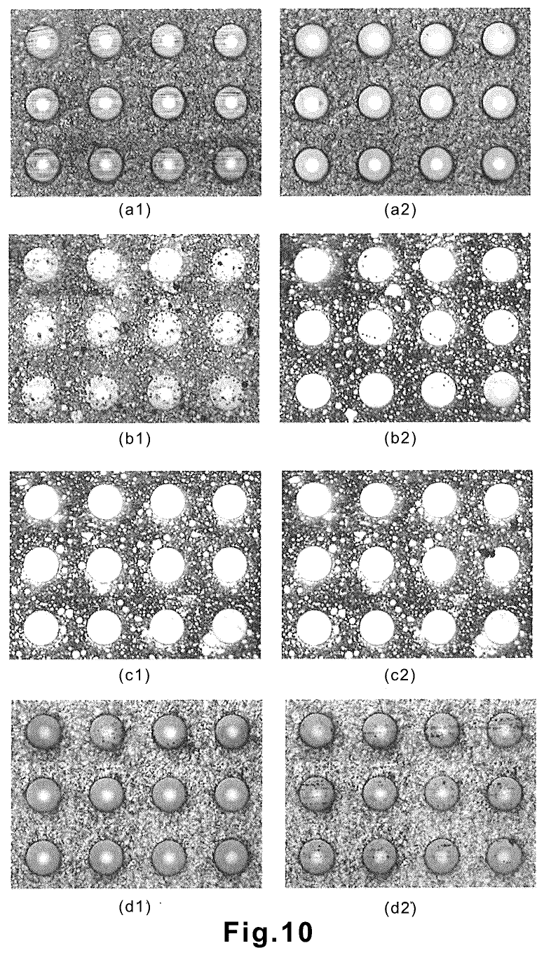

FIG. 10 shows some of the repeated connectors in the evaluated set of the thirty-one end face. For example, end face images (a1-a2) correspond to a same first connector, and produce vectors V1, V2. Also in FIG. 10, end face images (b1-b2) correspond to a same second connector, which product vectors V4 and V6. And also in FIG. 10, end face images (c1-c2) correspond to a same third connector that produces vectors V7 and V15.

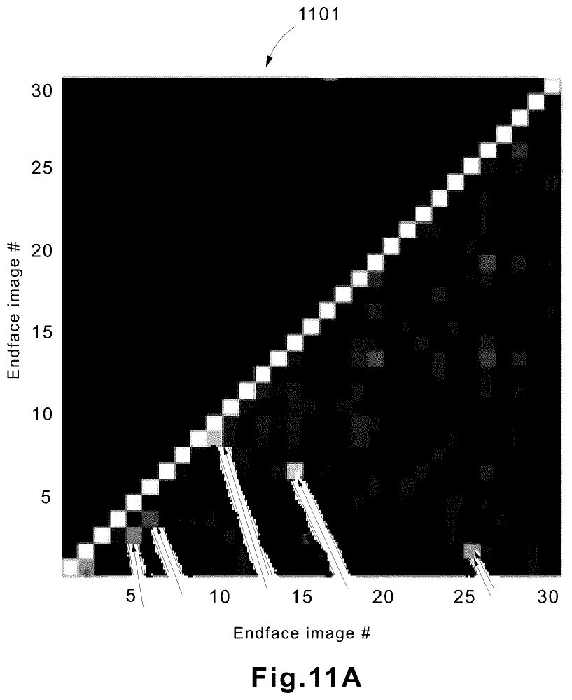

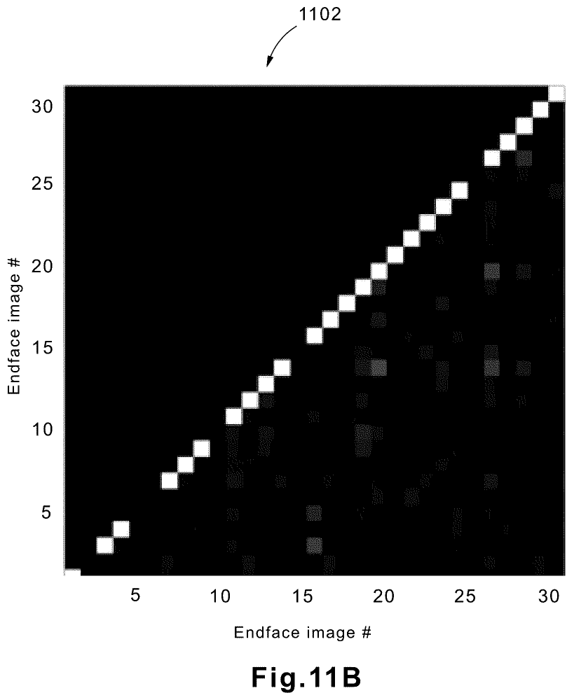

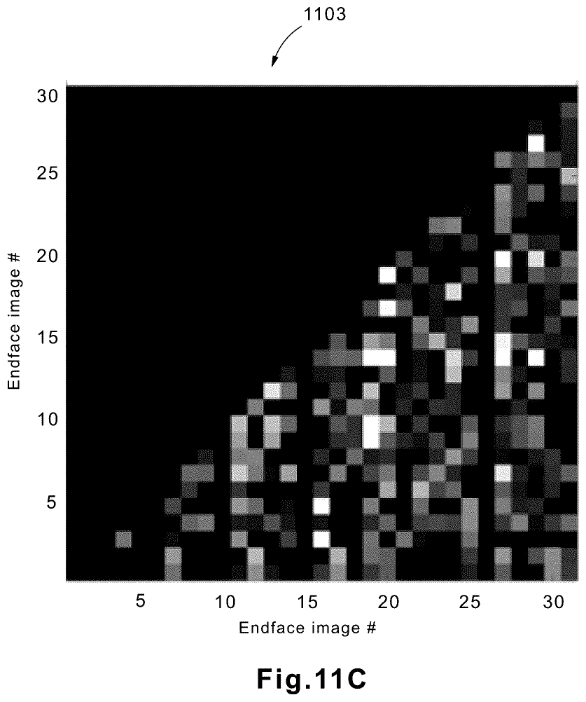

FIGS. 11A-11C show different cross-correlation matrixes 1101-1103 representing all the vectors V1-V31 that represent the thirty-one end face images. In cross-correlation matrix 1101-1103, brighter colors indicate a higher correlation, where the maximum value is one. In FIG. 11A, the cross-correlation matrix 1101 represents images from a same connector with diverse degrees of contamination. The repeated images are labeled on the side of the cross-correlation matrix 1101. The highest intensity diagonal represents an autocorrelation, which has a value equal to one. The cross-correlation matrix 1101 shows that the images of similar connectors have significantly higher correlation values than when different connectors are compared. Even though the contamination levels are different values around 0.6 could be achieved when the connector is the same, whereas correlations between different connectors are typically well below 0.25.

In FIG. 11B, the cross-correlation matrix 1102 is produced by removing repeated connectors from the cross-correlation matrix 1101. This shows that the method B provides a low risk of detecting incorrect connectors. At least 5.6 dB SNR was obtained in this example.

In FIG. 11C, the cross-correlation matrix 1103 is produced by further removing the autocorrelation (i.e., the diagonal with one value) and amplifying the cross-correlation by a factor of 10 to show the random characteristics of the cross-correlations. These cross-correlation matrixes 1101-1103 show that recognition of a high correlation of similar connectors, even when contamination is present, may be achieved by the present solution.

So, the disclosed methods A and B may be utilized by the present solution to identify optical connectors based on the observed natural randomness of characteristics found on their connector end face. Method B, which estimates statistical metrics that quantify the degree of correlations among different regions in the connector end face, may be more robust to discriminating connectors in the presence of image variations, or noise, due to contamination.

These identification method may be used for the connectors or fiber components with the connectors such as cables, and cassettes among others. The problems that can be prevented by the present solution are numerous. First, the present solution may inspect for cleanliness and obtain ID in one step, thus reducing network deployment time while avoiding link failures due to contamination. At the same time, it can reduce problems with counterfeit products.

The identification and detection solutions from the disclosed methods are not necessarily limited to be applied to just the connector end face. For example, the material signature on the side of the connector or even the housing of the connector may be used to identify the connector. Moreover, a small piece of material, with a random structure, can be attached to any other device and used as an identification label. For example, a small piece of glass-filled polymer, with less than 2 square mm of area can be glued to an indented section on a cassette module. The fiber VIS may be any optical system consisting of a lens, illumination, and receiver can be used to read the label and identify the component using the methods described in this application.

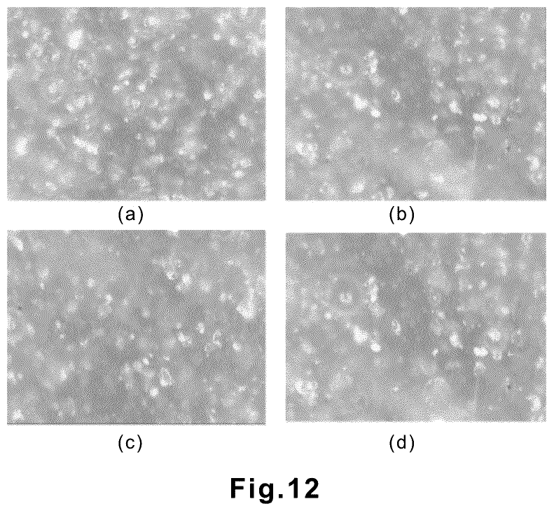

The methods described above can be enhanced when colored random structures are used. The color can added using die particles to the base material. FIG. 12 shows four different images (a), (b), (c), and (d) depicting regions of prepared colored material. The use of a colored material may improve the identification of the connectors using method B since the color adds a third dimension, that can be exploited in the computation of the cross-correlation to better discriminate among different connectors.

The material with the random patterns may not be limited to solid structures such as the ones in MPO connectors. Rubber-based labels with random microparticles may be produced and used as identifiers for other devices.

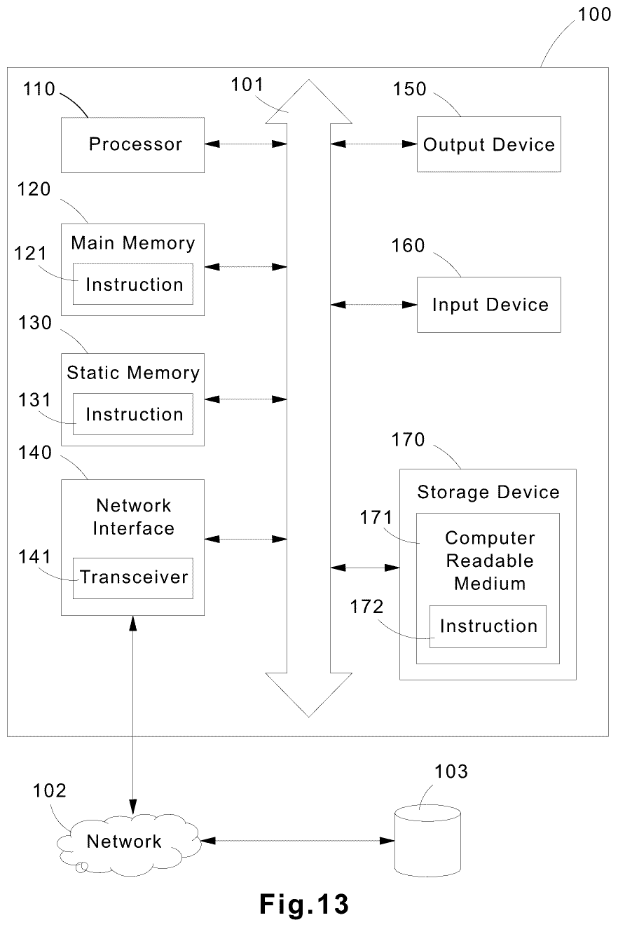

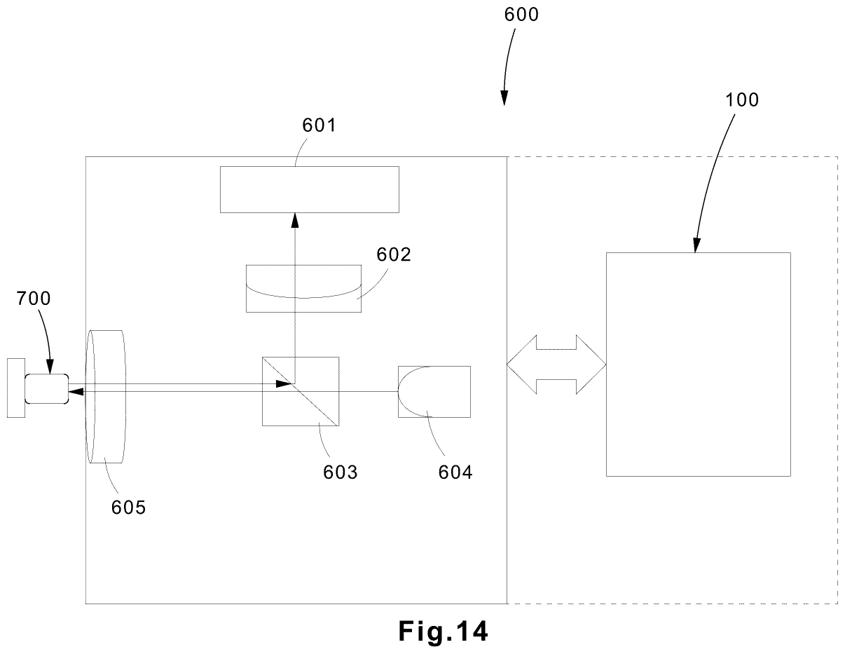

FIG. 13 illustrates an exemplary computer architecture for a computing device system 100. For example, the computing device system 100 may be representative of the components included in a computing device for implementing the features of the present solution described herein. As shown in FIG. 14, the computing device system 100 may be included as part of a fiber VIS 600, or be a separate device configured to be in communication with the fiber VIS 600. Although not specifically illustrated, the computing device system 100 may additionally include software, hardware, and/or circuitry for implementing attributed features as described herein.

The computing device system 100 includes a processor 110, a main memory 120, a static memory 130, an output device 150 (e.g., a display or speaker), an input device 160, and a storage device 170, communicating via a bus 101. The bus 101 may represent one or more busses, e.g., USB, PCI, ISA (Industry Standard Architecture), X-Bus, EISA (Extended Industry Standard Architecture), or any other appropriate bus and/or bridge (also called a bus controller).

The processor 110 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 110 executes instructions 121, 131, 172 stored on one or more of the main memory 120, static memory 130, or storage device 170, respectively. The processor 110 may also include portions of the computing device system 100 that control the operation of the entire computing device system 100. The processor 110 may also represent a controller that organizes data and program storage in memory and transfers data and other information between the various parts of the computing device system 100.

The processor 110 is configured to receive input data and/or user commands through input device 160 or received from a network 102 through a network interface 140. The input device 160 may be a keyboard, mouse or other pointing device, trackball, scroll, button, touchpad, touch screen, keypad, microphone, speech recognition device, video recognition device, accelerometer, gyroscope, global positioning system (GPS) transceiver, or any other appropriate mechanism for the user to input data to computing device system 100 and control operation of computing device system 100. The input device 160 as illustrated in FIG. 13 may be representative of any number and type of input devices.

The processor 110 may also communicate with other computer systems via the network 102 to receive control commands or instructions 121, 131, 172, where processor 110 may control the storage of such control commands or instructions 121, 131, 172 into any one or more of the main memory 120 (e.g., random access memory (RAM)), static memory 130 (e.g., read only memory (ROM)), or the storage device 170. The processor 110 may then read and execute the instructions 121, 131, 172 from any one or more of the main memory 120, static memory 130, or storage device 170. The instructions 121, 131, 172 may also be stored onto any one or more of the main memory 120, static memory 130, or storage device 170 through other sources. The instructions 121, 131, 172 may correspond to, for example, instructions for implementing the disclosed solution, including, but not limited to, the processes for identifying, detecting, comparing, and confirming information as described herein with relation to method A and method B.

Although the computing device system 100 is represented in FIG. 13 as a single processor 110 and a single bus 101, the disclosed embodiments apply equally to computing device system that may have multiple processors and to computing device system that may have multiple busses with some or all performing different functions in different ways.

The storage device 170 represents one or more mechanisms for storing data. For example, the storage device 170 may include a computer readable medium 171 such as read-only memory (ROM), RAM, non-volatile storage media, optical storage media, flash memory devices, and/or other machine-readable media. In other embodiments, any appropriate type of storage device may be used. Although only one storage device 170 is shown, multiple storage devices and multiple types of storage devices may be present. Further, although the computing device system 100 is drawn to contain the storage device 170, it may be distributed across other computer systems that are in communication with the computing device system 100, such as a server in communication with the computing device system 100. For example, when the computing device system 100 is representative of the user device, the storage device 170 may be distributed across to include a database 103 that is part of a cloud storage platform, and which is accessible via communication through the network 102. The database 103 may require credentials to be authenticated before access is granted.

The storage device 170 may include a controller (not shown) and a computer readable medium 171 storing instructions 172 capable of being executed by the processor 110 to carry out the features relating to the technical solutions such as the method A and method B solutions, and the processes described in flowcharts 200, 300, described herein. In another embodiment some, or all, the functions are carried out via hardware in lieu of a processor-based system. In some embodiments, the included controller is a web application browser, but in other embodiments the controller may be a database system, a file system, an electronic mail system, a media manager, an image manager, or may include any other functions capable of accessing data items.

The output device 150 is configured to present information to the user. For example, the output device 150 may be a display such as a liquid crystal display (LCD), a gas or plasma-based flat-panel display, or a traditional cathode-ray tube (CRT) display or other well-known type of display that may, or may not, also include a touch screen capability. Accordingly, the output device 150 may function to display a graphical user interface (GUI) such as the GUI for enabling a user to control the AV equipment, as described herein. In other embodiments, the output device 150 may be a speaker configured to output audible information to the user. In still other embodiments, any combination of output devices may be represented by the output device 150.

Computing device system 100 also includes the network interface 140 that allows communication with other computers via the network 102, where the network 102 may be any suitable network and may support any appropriate protocol suitable for communication to/from computing device system 100. In an embodiment, the network 102 may support wireless communications. In another embodiment, the network 102 may support hard-wired communications, such as a telephone line or cable. In another embodiment, the network 102 may support the Ethernet IEEE (Institute of Electrical and Electronics Engineers) 802.3x specification. In another embodiment, the network 102 may be the Internet and may support IP (Internet Protocol). In another embodiment, the network 102 may be a LAN or a wide area network (WAN). In another embodiment, the network 102 may be a hotspot service provider network. In another embodiment, network 102 may be an intranet. In another embodiment, the network 102 may be a GPRS (General Packet Radio Service) network. In another embodiment, the network 102 may be any appropriate cellular data network or cell-based radio network technology. In another embodiment, the network 102 may be an IEEE 802.11 wireless network. In another embodiment, the network 102 may be representative of an Internet of Things (IoT) network. In still another embodiment, the network 102 may be any suitable network or combination of networks. Although one network 102 is shown in FIG. 13, the network 102 may be representative of any number of networks (of the same or different types) that may be utilized.

The network interface 140 provides the computing device system 100 with connectivity to the network 102 through any compatible communications protocol. The network interface 140 sends and/or receives data from the network 102 via a wireless or wired transceiver 141. The transceiver 141 may be a cellular frequency, radio frequency (RF), infrared (IR), Bluetooth, or any of a number of known wireless or wired transmission systems capable of communicating with the network 102 or other computer device having some or all of the features of the computing device system 100. The network interface 140 as illustrated in FIG. 13 may be representative of a single network interface card configured to communicate with one or more different data sources. Furthermore, the network interface 140 may be representative of data communication ports such as ethernet, universal serial bus (USB), power over ethernet (POE), or single pair ethernet (SPE).

The computing device system 100 may be implemented using any suitable hardware and/or software, such as a personal computer or other electronic computing device. In addition, the computing device system 100 may also be a smartphone, portable computer, laptop, tablet or notebook computer, PDA, appliance, IP telephone, server computer device, cloud service platform, or mainframe computer.

FIG. 14 shows an exemplary fiber VIS 600 according to an embodiment of this disclosure. The fiber VIS 600 may be representative of any of the fiber VIS devices described herein. The fiber VIS 600 may also be representative of a visual inspection tool described in one or more of U.S. Non-provisional Ser. No. 18/097,533 (filed Jan. 17, 2023), U.S. Non-provisional Ser. No. 17/026,591 (filed Sep. 21, 2020), U.S. Non-provisional Ser. No. 17/447,603 (filed Sep. 14, 2021), or U.S. Non-provisional Ser. No. 18/097,533 (filed Jan. 17, 2023), all of which are hereby incorporated by reference herein.

The fiber VIS 600 is shown to include the computing device system 100 according to some embodiments, while in other embodiments the fiber VIS 600 may be a separate device that is configured to communicate with the computing device system 100. The fiber VIS 600 includes a light source 604, a beam splitter 603, an inspection lens 605, a focus lens 602, and an image capturing sensor 601. The fiber VIS 600 is configured to capture an image of a connector end face 700. The light source 604 emits a beam of light through the beam splitter 603, where at least a portion of the light beam travels through the inspection lens 605, reflects off the connector end face 700, reflects back through the inspection lens 605, reflects off the beam splitter 603 towards the focus lens 602, and travels through the focus lens 602 before landing on the image capturing sensor 601. The captured image of the connector end face 700 may be transmitted to the computing device system 100, where the captured image may be stored on the computing device system 100, or in addition or alternatively, the captured image may be further transmitted by the computing device system 100 to a remote storage such as the database 103. The stored captured image may later be shared or made available to a vendor to compare against an image of the connector end face 700 at the installation site, as described herein.

In general, the described methods can be used to identify not only the connectors but also the passive or active network devices that utilize those connectors. For example, a cassette with six MPO ports where each MPO has an ID (a vector) that may be retrieved using method B described above. A database provided by the vendors relates the six vectors to the cassette ID, the cassette ID is expressed as a number, a barcode, or a quick response code or RFID. Thus, once one connector is identified, the cassette is also identified. A similar approach may be followed with network cables or other devices in the network such as transceivers, enabling identification of the network devices while their connectors are inspected.

The identification of network devices, and in particular fiber components, based on physical signatures from their components is relevant today as datacenters confront numerous security threats. To address these challenges, new and secure technologies have emerged, relying on advanced VPNs, and firewalls. However, the effectiveness of those technologies is diminished when physical security is compromised. Counterfeit optical components may be used by malicious agents to degrade the security of the network from inside the network (behind firewalls). In this context, the disclosed solution, which provides physical layer authentication of devices improves the security of communication networks.

According to some embodiments, a method to generate identifiers from images or video of surfaces that exhibit randomness is disclosed. The randomness may be attributed to randomly distributed particles embedded in a material of the surface, wherein the method computes metrics that measure the degree of similarity or dissimilarity among regions on the surface, wherein the location of the regions are relative to one or more fiduciary markers, or identifiable elements in the surface such as a fiber in an optical connector or a permanent defect in the surface, wherein the metrics are grouped in a matrix or a vector, wherein the vector or matrix can be used as identifiers, wherein the absolute value of the cross-correlation of identifiers from two different surfaces, is below 0.5.

The surface may correspond to an end face of a fiber connector, and the material of the surface may include a polymer with embedded glass particles, wherein an image of the surface is converted to a matrix or vector and used as an identifier or ID of the fiber component that includes the fiber connector. The fiber component may be the fiber connector itself, an assembly of fiber cables, or a fiber cassette that uses the connector. An absolute value of the cross-correlation of the identifiers from two different connectors may typically be below 0.3.

The metric that quantifies the degree of similarity or dissimilarity among regions on the same surface may be obtained using normalized cross-correlation between the regions.

The image capturing device for capturing the image of the surface may be an apparatus that inspects single, duplex, or parallel optical connectors, or optical connector and adapter assembly, wherein an illumination system sends light from an optical source to an optical system comprised of a set of lenses, beam splitter, and mirrors, wherein the apparatus has processing capabilities to execute the features and processes described herein.

The image capturing device for capturing the image of the surface may be an apparatus that inspects single, duplex, or parallel optical connectors, or optical connector and adapter assembly, wherein an illumination system sends light from an optical source to an optical system comprised of a set of lenses, beam splitter, and mirrors, wherein the illuminated connector reflects the light to an image sensor using an optical system, wherein the apparatus has processing capabilities to compute correlations among different regions of the captured image, wherein the regions size is less than 50000 pixels.

According to some embodiments, a method to identify devices used in communication networks by using randomness present at least one element of the devices, e.g., the end face of an MPO connector in a fiber component (e.g., a fiber cassette, a fiber cable, or an optical transceiver including a fiber connector) is disclosed. The method may compute metrics that quantify the degree of similarity or dissimilarity among regions on the surface of the mentioned element, wherein the metrics are grouped in a matrix or vectors, wherein the matrix or vectors can be used as an identifier of the element, wherein the element identifier is associated to the network device ID, in a local or distributed database, wherein the absolute value of the cross-correlation of identifiers from two different elements, is below 0.5.

According to some embodiments, a method to identify counterfeit devices in communication networks by using randomness present at least one element of the devices (e.g., a fiber cassette, a fiber cable, or an optical transceiver including a fiber connector) is disclosed. The method may compute metrics that quantify the degree of similarity or dissimilarity among regions on the surface of the mentioned element, wherein the metrics are grouped in a matrix or vectors, wherein the matrix or vectors can be used as an identifier of the element, wherein the element identifier is associated to the network device ID, in a local or distributed database, wherein the absolute value of the cross-correlation of identifiers from two different elements, is below 0.4.

The disclosed methods may improve the security of the network, by avoiding introducing unsafe elements in the network.

Furthermore, while the particular embodiments described herein have been shown and described, it will be obvious to those skilled in the art that changes and modifications may be made without departing from the teachings of the fiber component detection and inspection solution described herein. The matter set forth in the foregoing description and accompanying drawings is offered by way of illustration only and not as limitation. The scope of the different embodiments described herein are intended to be defined in the following claims when viewed in their proper perspective.

What is claimed is:

1. A visual inspection system comprising:
a memory configured to store machine executable instructions; and
a processor in communication with the memory, the processor configured to execute the machine executable instructions to cause the processor to:
receive a captured image of a connector at a field-side location, the connector included in a fiber component;
compute a hash function on the captured image to produce a field-side identifier for the fiber component;
access a production-side identifier;
compare the field-side identifier with the production-side identifier to determine whether there is a match between the field-side identifier and the production-side identifier; and
approve an assignment of an identification reference to the fiber component when the field-side identifier and the production-side identifier are determined to match.

2. The visual inspection system of claim 1, wherein the captured image of the connector at the field-side location includes at least a portion of a connector end face of the connector.

3. The visual inspection system of claim 2, wherein the processor is further configured to execute the machine executable instructions to cause the processor to:
execute an image analysis on the captured image to determine whether the connector end face is clean based on a predetermined standard; and
compute the hash function on the captured image to produce a field-side identifier for the fiber component when the connector end face is determined to be clean.

4. The visual inspection system of claim 1, wherein the captured image of the connector at the field-side location includes at least a portion of a connector housing of the connector.

5. The visual inspection system of claim 1, wherein the captured image of the connector at the field-side location includes an identifying feature added to the connector.

6. The visual inspection system of claim 1, wherein the hash function includes a hashing of the captured image with at least one additional information, the additional information including at least one of a fiber component part number, fiber component manufacturer, fiber component manufactured date, fiber component attribute, a test operator name, or other test data.

7. The visual inspection system of claim 1, wherein the production-side identifier is a product of the hash function computed at a production-side location, wherein the hash function computed on the production-side includes an earlier captured image of the connector captured at the production-side location.

8. The visual inspection system of claim 1, wherein the field-side identifier is one of a barcode or a numerical identifier.

9. The visual inspection system of claim 1, wherein the production-side identifier is one of a barcode or a numerical identifier.

10. The visual inspection system of claim 1, wherein the production-side identifier is accessed from a database requiring credentials for access.

11. A visual inspection system comprising:
a memory configured to store machine executable instructions; and
a processor in communication with the memory, the processor configured to execute the machine executable instructions to cause the processor to:
receive a field-side captured image of a connector at a field-side location, the connector included in a fiber component;
execute a vector image analysis to identify physical attributes on the field-side captured image corresponding to physical attributes on the connector;
access a production-side captured image for the connector;
compare the field-side captured image with the production-side captured image to determine whether there is a match between the physical attributes identified on the field-side captured image and physical attributes identified on the production-side captured image; and
approve an assignment of an identification reference to the fiber component when the field-side captured image and the production-side captured image are determined to match.

12. The visual inspection system of claim 11, wherein the captured image of the connector at the field-side location includes at least a portion of a connector end face of the connector.

13. The visual inspection system of claim 12, wherein the processor is further configured to execute the machine executable instructions to cause the processor to:
execute an image analysis on the captured image to determine whether the connector end face is clean based on a predetermined standard; and
execute a vector image analysis to identify physical attributes on the field-side captured image corresponding to physical attributes on the connector end face when the connector end face is determined to be clean.

14. The visual inspection system of claim 11, wherein the captured image of the connector at the field-side location includes at least a portion of a connector housing of the connector.

15. The visual inspection system of claim 11, wherein the captured image of the connector at the field-side location includes an identifying feature added to the connector.

16. The visual inspection system of claim 11, wherein the field-side captured image is partitioned into a plurality of regions of interest (ROI); and
wherein the processor is configured to execute the machine executable instructions to cause the processor to compare the field-side captured image with the production-side captured image by comparing a ROI included in the field-side image with a ROI included in the production-side image.

17. The visual inspection system of claim 11, wherein the field-side captured image is partitioned into a plurality of regions of interest, and each region of interest includes at least one feature-region of interest; and
wherein the processor is configured to execute the machine executable instructions to cause the processor to compare the field-side captured image with the production-side captured image by comparing a feature-ROI included in the field-side image with a feature-ROI included in the production-side image.

18. The visual inspection system of claim 11, wherein the captured image of the connector at the field-side location includes at least a portion of a connector end face of the connector and a physical identifier added to the connector end face.

19. The visual inspection system of claim 11, wherein the field-side captured image is partitioned into a plurality of regions of interest (ROI), wherein each ROI corresponds to a vector ID for the fiber component.

20. The visual inspection system of claim 11, wherein the production-side captured image is accessed from a database requiring credentials for access.
